(19) United States
(12) Patent Application Publication
(10) Pub. No.: US 2022/0291736 A1
(43) Pub. Date: Sep. 15, 2022

(54) FUNCTION ACTIVATIONS VIA DISPLAY DEVICE DEPRESSIONS

(71) Applicant: Hewlett-Packard Development Company, L.P., Spring, TX (US)

(72) Inventors: Yow-Wei Cheng, Taipei City (TW); Chia-Wei Ting, Taipei City (TW)

(73) Assignee: Hewlett-Packard Development Company, L.P., Spring, TX (US)

(21) Appl. No.: 17/637,652

(22) PCT Filed: Nov. 14, 2019
(86) PCT No.: PCT/US2019/061411

§ 371 Date: Feb. 23, 2022

(51) Int. Cl. G06F 1/3218; G06F 1/3212; G06F 1/3234; G06F 1/16

(52) U.S. Cl. CPC G06F 1/3218; G06F 1/3212; G06F 1/3265; G06F 1/1671; G06F 1/1637

(57) ABSTRACT

An example electronic device includes a display device and a physical button disposed below the display device, where a depression of the display device is to engage the physical button to change a power state of the electronic device.

### BACKGROUND

An electronic device, such as a laptop computer, a smartphone, a tablet computer, etc. may include a main display device to show different information to a user of the electronic device during an operation of the electronic device.

### BRIEF DESCRIPTION OF THE DRAWINGS

Some examples of the present application are described with respect to the following figures:

FIG. 1A illustrates an electronic device having a switch aligned with a display device, according to an example;

FIG. 1B is an exploded view of the switch aligned with the display device of FIG. 1A, according to an example;

FIG. 2A illustrates an electronic device having a physical button disposed below a display device, according to an example;

FIG. 2B is an exploded view of the physical button disposed below the display device of FIG. 2A, according to an example;

FIG. 3 illustrates an electronic device having a physical button disposed below a display device, according to another example;

FIG. 4A-4E illustrate information to be displayed on a display device, according to examples;

FIG. A illustrates a location of a display device in a housing of an electronic device, according to an example;

FIG. 5B illustrates a location of a display device in a housing of an electronic device, according to another example; and

FIG. 6 illustrates an electronic device having a display device controller to adjust an update frequency of a display device, according to an example.

### DETAILED DESCRIPTION

An electronic device, such as a laptop computer, a smartphone, a tablet computer, etc. may include a main display device to show different information to a user of the electronic device during an operation of the electronic device. However, when the electronic device is powered off, the main display device is also powered off. Thus, information related to the electronic device, such as a state of charge of a battery, may not be able to be displayed.

Examples described herein provide an approach to display information even when an electronic device is powered off. In an example, an electronic device may include a display device and a physical button disposed below the display device, where a depression of the display device is to engage the physical button to change a power state of the electronic device.

In another example, an electronic device may include a display device and a physical button disposed below the display device, where a depression of the display device is to engage the physical button to change a power state of the electronic device. The electronic device may also include a display device controller to adjust an update frequency of the display device based on the power state of the electronic device.

In another example, an electronic device may include a display device and a switch aligned with the display device, where a depression of the display device is to engage the switch to activate a function of the electronic device. The electronic device may also include a display device controller to adjust an update frequency of the display device based on a power consumption information of the electronic device. Examples described herein may enable an electronic device to display information even during a powered off state while minimizing the power consumption associated with displaying the information.

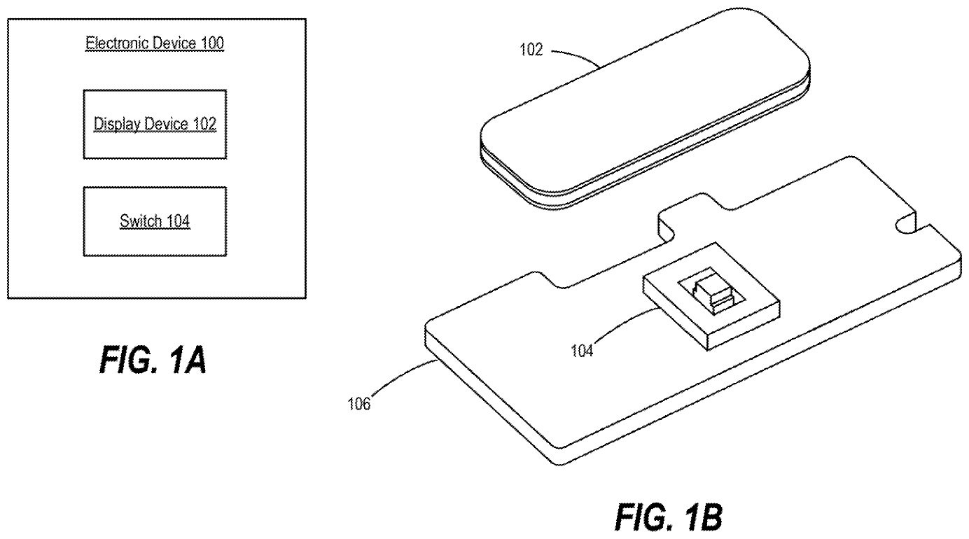

FIG. 1A illustrates an electronic device 100 having a switch aligned with a display device, according to an example. Electronic device 100 may be, for example, a notebook computer, a desktop computer, an all-in-one system, a tablet computing device, a mobile phone, an electronic book reader, or any electronic device suitable to have a display device.

Electronic device 100 may include a display device 102 and a switch 104. Display device 102 may be implemented using a bi-stable display panel. As used herein, a bi-stable display panel is a display panel where an image may be displayed and maintained in the display panel without the continuous application of power to the display panel. In some examples, display device 102 may be implemented using a electrophoretic display (also referred to as electronic ink technology) panel. Other bi-stable display technologies, such as a cholesteric liquid crystal display (ChLCD) display panel, an electro-phoretic display (EPD) panel, an electrowetting display (EWD) panel, and a quick response-liquid powder display (QR-LPD) panel, may also be used to implement display device 102. Switch 104 may be a device to make and break a connection in a circuit. Switch 104 may be implemented as a mechanical switch.

As described in more detail in FIG. 1B, display device 102 and switch 104 may be disposed in a housing of electronic device 100. Switch 104 may be aligned with display device 102 such that a physical depression of display device 102 (e.g., by a finger) may activate switch 104 to change a function of electronic device.

Turning to FIG. 1B, FIG. 1B is an exploded view of switch 104 aligned with display device 102 of FIG. 1A, according to an example, Switch 104 may be mounted on a circuit board 106 of electronic device 100. Display device 102 may be positioned above switch 104 such that display device 102 overlaps with switch 104. Thus, when display device 102 is depressed, display 102 may come into contact with switch 104 to activate switch 104. The activation of switch 104 may change a function of electronic device 100, such as changing a power state of electronic device 100 (e.g., turning on or off electronic device 100 via switch 104).

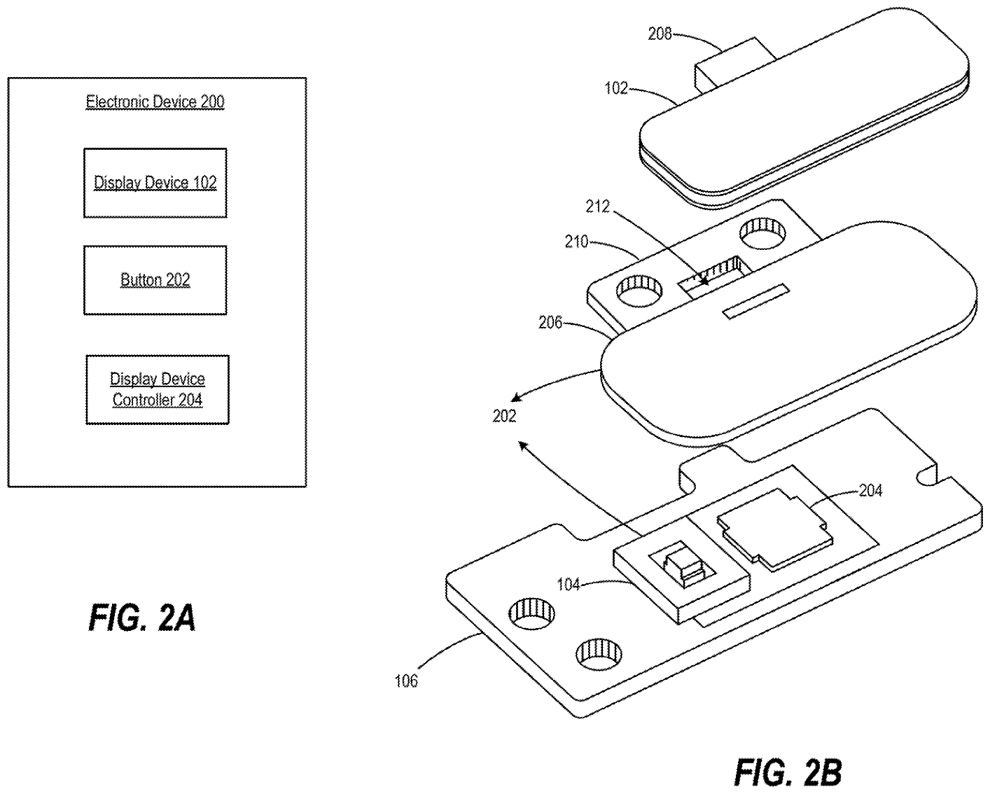

FIG. 2A illustrates an electronic device 200 having a physical button 202 disposed below display device 102, according to an example. Electronic device 200 may implement electronic device 100 of FIG. 1A. Electronic device 200 may include display device 102, button 202, and a display device controller 204. As described in more detail in FIG. 2B, button 202 may include switch 104 of FIG. 1. Display device controller 204 may control operations of display device 102.

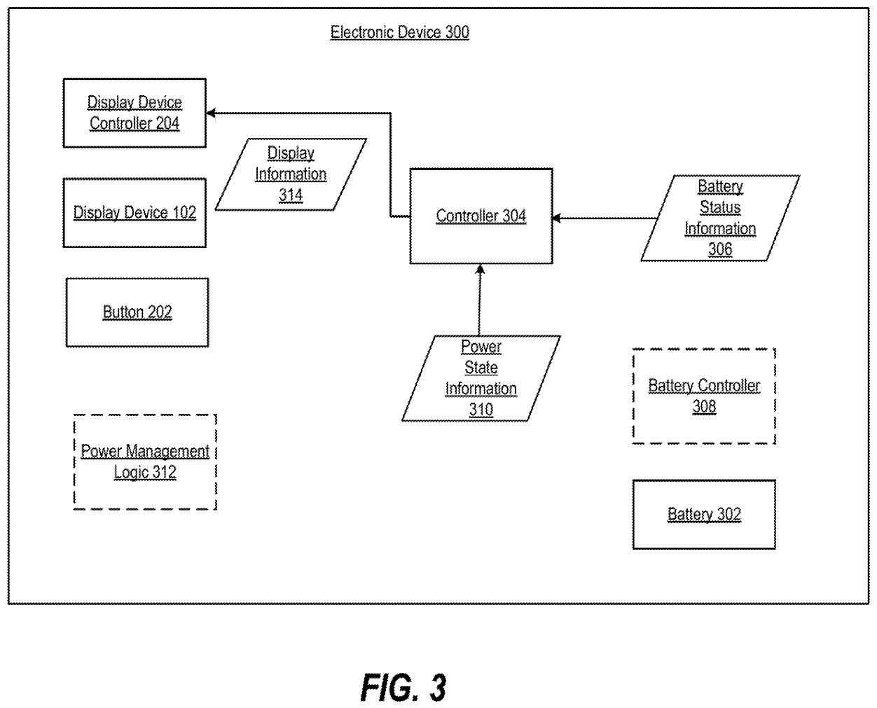

During operation, display device controller 204 may receive information from various components of electronic device 200, such as a processor, a battery controller, power management logic, etc. Display device controller 204 may control display device 102 to cause the information to be displayed on display device 102. As described in more detail in FIG. 3, display device controller 204 may adjust an update frequency of 102 display device based on the power state of electronic device 200.

FIG. 2B is an exploded view of physical button 202 disposed below 102 display device of FIG. 2A, according to an example. Button 202 may include switch 104 of FIG. 1 and a button member 206. Button member 206 may be disposed below display device 102 to provide structural support for display device 102. Display device 102 may be mounted or rested on top of button member 206. Button member 206 may be made from a variety of materials, such as metal, plastic, etc. Button member 206 may be shaped to provide sufficient surface area to support the entire display device 102.

Button member 206 may be disposed above switch 104 such that button member 206 is disposed between display device 102 and switch 104. Thus, when display device 102 is depressed, the depression may also depress button member 206 to activate switch 104.

In some examples, display device controller 204 may be mounted on circuitry board 106. Display device controller 204 may be connected to display device 102 via a cable 208. Cable 208 may pass through a mounting plate 210 of button member 206 via an aperture 212 of mounting plate 210.

FIG. 3 illustrates an electronic device 300 having a physical button disposed below a display device, according to another example. Electronic device 300 may implement electronic device 100 of FIG. 1A, electronic device 200 of FIG. 2A, or any combination thereof.

Electronic device 300 may include display device 102, button 202, display device controller 204, a battery 302, and a controller 304. Battery 302 may provide electrical power to electronic device 300 when electronic device 300 is not plugged into an electrical outlet. Battery 302 may provide power to different components of electronic device 300, such as display device 102 and display device controller 204. Controller 304 may be implemented using hardware (e.g., a semiconductor-based microprocessor, circuitry), processor executable instructions, or a combination thereof.

During operation, controller 304 may determine battery status information 306. Battery status information 306 may include a state of charge of battery 302, whether battery 302 is being charged, or a combination thereof. In some examples, controller 304 may receive battery status information 306 from a battery controller 308 of electronic device 300 that control operations of battery 302. Battery controller 308 may control operations of battery 302. In some examples, controller 304 be implemented as battery controller 308 and controller 304 may generate battery status information 306 by directly monitoring battery 302.

Controller 304 may also determine power state information 310 that indicates a power state of electronic device 300. In some examples, electronic device 300 may implement the Advanced Configuration and Power Interface (ACPI) specification to perform power management of electronic device 300. In some examples, electronic device 300 may include power management logic 312 to perform power management based on the ACPI specification. Power management logic 312 may be implemented using hardware (e.g., a semiconductor-based microprocessor, circuitry), processor executable instructions, or a combination thereof, Power management logic 312 may transmit power state information 310 to controller 304.

Power state information 310 may indicate a power state of electronic device 300. Under the ACPI specification, electronic device 300 may operate under 6 different power states: S0, S1, S2, S3, S4, and S5. Thus, as an example, when electronic device 300 is in the S0 state, power state information 310 may include information that indicates electronic device 300 is in the S0 state.

Controller 304 may generate display information 314 by converting battery status information 306, power state information 310, or a combination thereof, to a format that is accepted by display device controller 204. In response to receiving display information 314, display device controller 204 may control display device 102 to show display information 314 on display device 102.

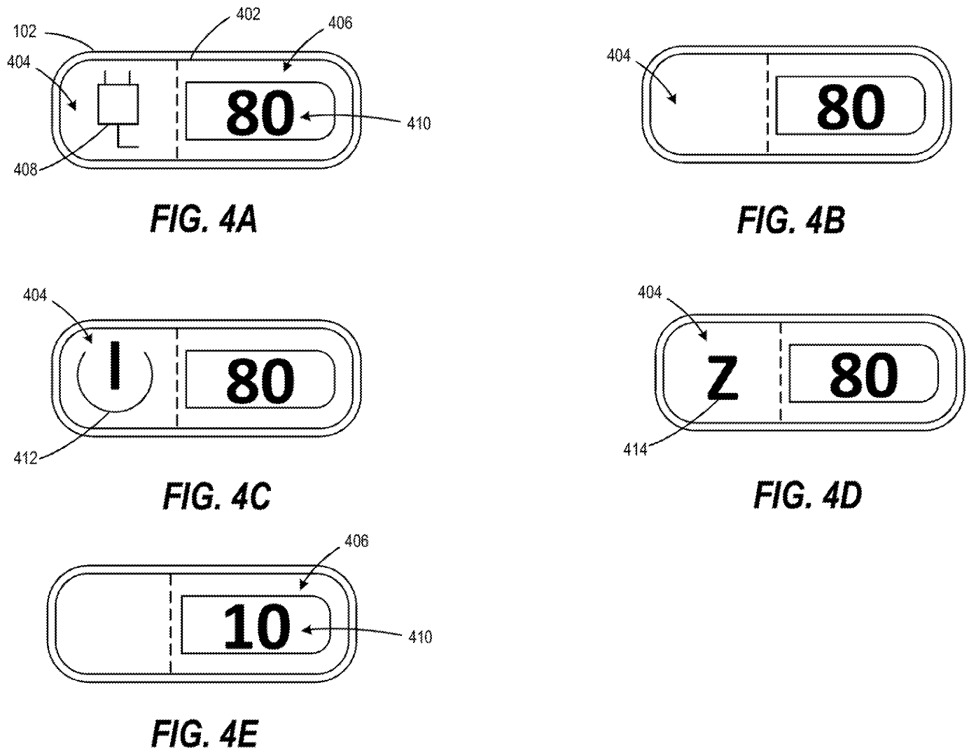

FIG. 4A-4E illustrate information to be displayed on display device 102, according to examples. Turning to FIG. 4A, display device 102 may include a display surface 402. Display surface 402 may include a plurality of regions to show different kinds of information. Display device controller 204 may control and configure the number of regions in display surface 402. As illustrated in FIG. 4A, display surface 402 may include a first region 404 and a second region 406. Display device controller 204 may direct display device 102 to display battery charging information in first display region 404. A power adaptor icon 408 may be shown in first region 404 to indicate that battery 302 is being charged. Display device controller 204 may direct display device 102 to display state of charge information of battery 302 in second region 406. A numerical icon 410 may be shown in second region 406 to indicate a percentage of charge remaining in battery 302.

Turning to FIG. 4B, when battery 302 is not being charged, display device controller 204 may update first region 404 to remove power adaptor icon 408 so that first region 404 is blank.

In some examples, power state information of electronic device 300 may be displayed in first region 404. Turning to FIG. 4C, electronic device 300 may be in an off state, such as the S5 state under the ACPI specification. A button icon 412 may be displayed in first region 404. Button icon 412 may indicate to a user to press on display device 102 to power on electronic device 300.

Turning to FIG. 4D, as another example, electronic device 300 may be in a sleep state, such as the S3 state under the ACPI specification, A letter “Z” icon 414 may be displayed in first region 404. Letter “Z” icon 424 may indicate to a user to press on display device 102 to wake electronic device 300 from the sleep state.

Turning to FIG. 4E, in some examples, when the state of charge of battery 302 is below a threshold, display device controller 204 may configure display device 102 to display the state of charge information in a manner that is more likely to draw a user's attention. As illustrated in FIG. 4E, the state of charge of battery 302 may be a 10%, which is below a threshold of 20%. Thus, display device controller 204 may configure display device 102 to display numerical icon 410 in a bright color (e.g., red) instead of a dark color (e.g., black) to alert the user that battery 302 may need to be charged soon.

When display device 102 is displaying information, such as the power state information and the state of charge information, display device controller 204 may update the information displayed on display device 102, such as numerical icon 410 to show the current state of charge of battery 302, periodically according to an update frequency. For example, the update frequency may be updating the information displayed once every 10 seconds.

In some examples, display device controller 204 may adjust the update frequency based on the power state of electronic device 300 to reduce power consumption of display device 102. For example, when electronic device 300 is in a high power consumption state (e.g., the S0 state), electronic device 300 is running and a processor of electronic device 300 is executing instructions. Display device controller 204 may update the information displayed in display device 102 based on a first update frequency, such as once every minute.

When electronic device 300 is transitioned to a low power consumption state (e.g., the S3 state), display device controller 204 may reduce the update frequency to a second update frequency to reduce power consumption associated with displaying information in display device 102. For example, the second update frequency may be once every hour. When electronic device 300 is transitioned back to the high power consumption, display device controller 204 may increase the update frequency back to once every minute.

In some examples, display device controller 204 may adjust the update frequency based on a power consumption information of the electronic device 300. A power consumption information may include information that impacts the amount of power consumed by electronic device 300 in different power states. In some examples, the power consumption information may include a state of charge of battery 302. When the state of charge of battery 302 is within a threshold range (e.g., at least 90%), display device controller 204 may use a first update frequency of once every hour. When the state of charge of battery 302 is outside the threshold range (e.g., below 90%), display device controller 204 may use a second update frequency that is lower than the first update frequency. For example, the second update frequency may be once every 24 hours as a self-discharge rate of a battery is reduced when the state of charge is below 90%. Thus, updating the information shown on display device 102 (e.g., the state of charge information) less frequently based on the state of charge of battery 302 may reduce power consumption while maintaining a high accuracy of the information shown.

In some examples, the power consumption information may include battery identification information, such as a battery type of battery 302. For example, the power consumption information may indicate that battery 302 is a lithium-ion battery. Thus, display device controller 204 may adjust the update frequency based on the information that battery 302 is a lithium-ion battery, such as a first update frequency of once every hour between 100% to 90% state of charge and a second update frequency of once every 3 days for less than 90% state of charge.

As another example, the power consumption information may indicate that battery 302 is a nickel-cadmium battery. Thus, display device controller 204 may adjust the update frequency based on the information that battery 302 is a nickel-cadmium battery, such as a first update frequency of once every hour between 100% to 90% state of charge and a second update frequency of once every 24 hours for less than 90% state of charge.

In some examples, the power consumption information may include an amount of charge cycle of battery 302. Thus, display device controller 204 may use a first update frequency when the age of battery 302 is less than a threshold. Display device controller 204 may use a second update frequency when the age of battery 302 is greater than the threshold.

In some examples, the power consumption information may include component type information. For example, the component type information may include a type of processor in electronic device 300 (e.g., a single core processor, a multi-core processor), the speed of the processor, the number of cores in the processor, or a combination thereof. As another example, the component type information may include a type of random access memory in electronic device 300 (e.g., dynamic random access memory, static random access memory), the speed of the random access memory, or a combination thereof.

As another example, the component type information may include a type of non-volatile memory in electronic device 300 (e.g., a solid-state drive, a hard disk drive), the speed of the non-volatile memory, or a combination thereof. As another example, the component type information may include a type of display panel in electronic device (e.g., a liquid-crystal display panel, an organic light-emitting diode display panel). As another example, the component type information may include any combination of the examples described above.

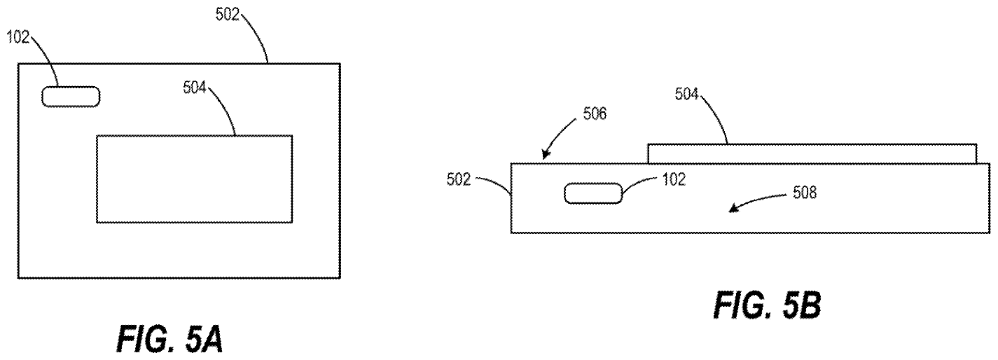

Display device 102 may be located on different surfaces of an electronic device based on the form factor of the electronic device, as described in more detail in FIGS. 5A-5B. Turning to FIG. 5A, which illustrates a location of display device 102 in a housing 502 of an electronic device, according to an example, Housing 502 may implement a housing of electronic device 300. An input device 504, such as a keyboard, a click pad, a touchpad, a touch-sensitive screen, may be located on a first surface 506 of housing 502, Display device 102 may also be located on the same first surface 506. Input device 504 may implement an input device of electronic device 300.

Turning to FIG. 5B, which illustrates a location of display device 102 in housing 502 of an electronic device, according to another example. As shown in FIG. 5B, display device 102 may be located on a second surface 508 of housing 502, which is different from first surface 506.

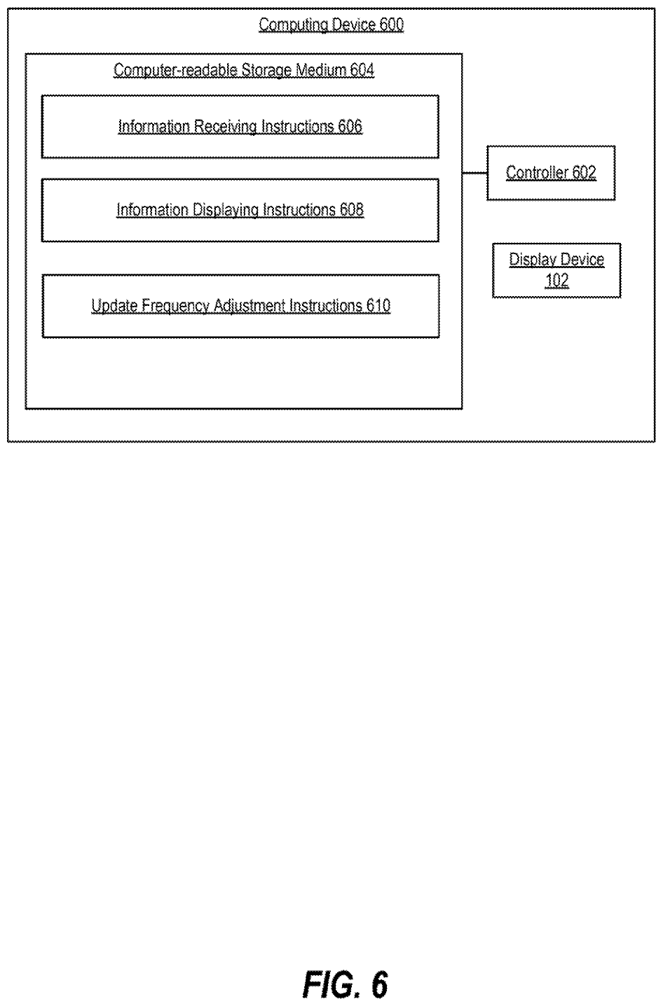

FIG. 6 illustrates an electronic device 600 having a display device controller to adjust an update frequency of a display device. example. Electronic device 600 may implement electronic device 100, 200, 300, or any combination thereof. Electronic device 600 may include a controller 602, a computer-readable storage medium 604, and display device 102.

Controller 602 may be a semiconductor-based microprocessor, and/or other hardware devices suitable for retrieval and execution of instructions stored in computer-readable storage medium 604. Controller 602 may implement display device controller 204 of FIGS. 2B-3. Controller 602 may fetch, decode, and execute instructions 606, 608, 610 to control operations of display device 102. As an alternative or in addition to retrieving and executing instructions, controller 602 may include at least one electronic circuit that includes electronic components for performing the functionality of instructions 606, 608, 610, or a combination thereof.

Computer-readable storage medium 604 may be any electronic, magnetic, optical, or other physical storage device that contains or stores executable instructions. Thus, computer-readable storage medium 604 may be, for example, Random Access Memory (RAM), an Electrically Erasable Programmable Read-Only Memory (EEPROM), a storage device, an optical disc, etc. In some examples, storage medium 604 may be a non-transitory storage medium, where the term “non-transitory” does not encompass transitory propagating signals. Computer-readable storage medium 604 may be encoded with a series of processor executable instructions 606, 608, and 610.

Information receiving instructions 606 may receive information to be displayed on display device 102. For example, referring to FIG. 3, display device controller 204 may receive display information 314 from controller 304.

Information displaying instructions 608 may direct display device 102 to display information. For example, referring to FIG. 4A, display device controller 204 may direct display device 102 to display battery charging information in first display region 404.

Update frequency adjustment instructions 610 may adjust an update frequency of display device 102. For example, display device controller 204 may adjust the update frequency based on the power state, the power consumption information of electronic device 300, or a combination thereof.

The use of “comprising”, “including” or “having” are synonymous and variations thereof herein are meant to be inclusive or open-ended and do not exclude additional unrecited elements or method steps.

What is claimed is:

1. An electronic device comprising:
a display device; and
a physical button disposed below the display device, wherein a depression of the display device is to engage the physical button to change a power state of the electronic device.

2. The electronic device of claim 1, wherein the physical button includes:
a button member to support the display device; and
a switch to change the power state of the electronic device.

3. The electronic device of claim 1, further comprising:
a housing having an input device, wherein the display device and the physical button are disposed in the housing, wherein the display device and the input device are located on the same surface of the housing.

4. The electronic device of claim 1, further comprising:
a housing having an input device, wherein the display device and the physical button are disposed in the housing, wherein the input device is located on a first surface of the housing, and wherein the display device is located on a second surface of the housing.

5. The electronic device of claim 1, wherein the display device includes a bi-stable display panel.

6. An electronic device comprising:
a display device;
a physical button disposed below the display device, wherein a depression of the display device is to engage the physical button to change a power state of the electronic device; and
a display device controller to adjust an update frequency of the display device based on the power state of the electronic device.

7. The electronic device of claim 6, further comprising a battery to provide power to the display device and the display device controller.

8. The electronic device of claim 7, wherein the display device includes a display surface to display information, wherein the display device controller is to:
direct the display device to display power state information of the electronic device in a first region of the display surface; and
direct the display device to display state of charge information of the battery in a second region of the display surface.

9. The electronic device of claim 7, wherein the display device includes a display surface to display information, wherein the display device controller is to:
direct the display device to display battery charging information of the electronic device in a first region of the display surface; and
direct the display device to display state of charge information of the battery in a second region of the display surface.

10. The electronic device of claim 6, wherein the display device controller is to:
update information displayed on the display device using a first update frequency when the electronic device is a high power consumption state; and
update the information using a second update frequency when the electronic device is in a low power consumption state, wherein the first update frequency is higher than the second update frequency.

11. An electronic device comprising:
a display device;
a switch aligned with the display device, wherein a depression of the display device is to engage the switch to activate a function of the electronic device; and
a display device controller to adjust an update frequency of the display device based on a power consumption information of the electronic device.

12. The electronic device of claim 11, further comprising a battery, wherein the power consumption information includes a state of charge of the battery.

13. The electronic device of claim 12, wherein the display device controller is to:
update information displayed on the display device using a first update frequency when the state of charge is within a threshold range; and
update the information using a second update frequency when the state of charge is outside the threshold range, wherein the second update frequency is lower than the first update frequency.

14. The electronic device of claim 11, further comprising a battery, wherein the power consumption information includes an amount of charge cycle of the battery.

15. The electronic device of claim 11, wherein the power consumption information includes component type information.
